(19) United States
(12) Patent Application Publication
(10) Pub. No.: US 2020/0223348 A1
(43) Pub. Date: Jul. 16, 2020

(54) Chain Rail Conveyor with Lift Gate

(71) Applicant: Keith Manufacturing Co., Madras, OR (US)

(72) Inventor: Tim Toth, Madras, OR (US)

(73) Assignee: Keith Manufacturing Co., Madras, OR (US)

(21) Appl. No.: 16/743,803

(22) Filed: Jan. 15, 2020

Related U.S. Application Data
(60) Provisional application No. 62/792,941, filed on Jan. 16, 2019.

(51) Int. Cl. B60P 1/44; B65G 23/44; B65G 15/14; B65G 15/62; B65G 15/64; B65G 21/20; B65G 21/22; B65G 37/00; B65G 15/00

(52) U.S. Cl. CPC B60P 1/4428; B65G 23/44; B65G 15/14; B65G 15/62; B65G 15/00; B65G 21/20; B65G 21/22; B65G 37/005; B65G 15/64

(57) ABSTRACT

A truck cargo lift gate is pivotable between an upstanding and horizontal position. The lift gate carries a low-profile, endless chain conveyor. After the lift gate is pivoted to the horizontal position, the lift gate and the chain conveyor carried thereby may be vertically lowered to the ground with a load on the lift gate.

### TECHNICAL FIELD

This is a disclosure of a chain rail conveyor system that is designed to be installed on an existing floor bed of a truck or similar vehicle. This disclosure is different from other designs because it includes a lift gate component to the design.

### BACKGROUND

In general, this disclosure relates to the type of load conveyor system that is disclosed in U.S. Pat. No. 10,087,011 (“the 011 patent”). The 011 patent describes a load conveyor system called a “chain rail” conveyor that has a pair of rails that carry endless chains.

One or both of the rails may have motor(s) sized to fit within the vertical height or vertical envelope of the rail. An endless chain rides on each rail, with the chain being motor-driven. A load (i.e., loaded pallet or the like) rests on the chains (that is, a pair of chains corresponding to a pair of rails, with the pallet straddling this arrangement), and is moved, in one direction or another, depending on the direction of chain movement.

Because the motor(s) fit within the vertical height of the rail(s), the load can pass over the motor. This type of conveyor design is adapted to be installed on the floor bed of a truck as an aftermarket installation, with the conveyor system providing a means for quickly moving palletized loads to the back end of the truck for loading or unloading, as the case may be.

The description and teachings of the 011 patent are incorporated here by reference and should be regarded as part of the present disclosure.

### SUMMARY

Many transport trucks have “lifts” or lift platforms built into the tailgate region of the truck. These platforms allow loads to be moved from the truck bed (for example, from inside the cargo area of a box truck) onto the platform, followed by lowering it to the ground where the load is then removed from the platform. The present design allows for the kind of load conveyor system described in the 011 patent to be used in conjunction with a lift platform. Lift platforms are also called “lift gates.”

With respect to the present disclosure, the truck bed or floor carries a first endless chain conveyor. This chain conveyor consists of multiple chain rails that can move a load from forward to rearward ends of the truck, or vice versa.

A lift gate is located at the rearward end of the truck adjacent to an exit end of the floor. The lift gate is pivotable about an axis between a generally upstanding position (for when the truck is moving in transportation mode) to a generally horizontal position (for loading or unloading the truck).

The lift gate carries a second endless chain conveyor that operates similarly to the first endless chain conveyor carried by the truck floor. In other words, the second endless chain conveyor is motor-driven, but the drive motor does not protrude above the vertical height of the conveyor, so that a load may pass over the top.

When the lift gate is first pivoted to the generally horizontal position, the second endless chain conveyor (on the lift gate) moves into conveying alignment with the first endless chain conveyor (on the truck floor). This enables the load on the truck floor to be moved or transferred via the first endless chain conveyor onto the second endless chain conveyor on the lift gate. The two chain conveyors move in cooperation with each other as the load moves onto the lift gate.

Thereafter, when the liftgate is in the generally horizontal position, it may then be moved vertically downward, for lowering the lift gate to the ground. The load (or part of the load) that has been moved onto the lift gate is likewise lowered to the ground to a position where the load can be removed from the lift gate.

While the above summarizes the overall system as being used to unload cargo from a truck, or the like, it is to be understood that the system may be used in reverse, i.e., for loading the truck. The chain conveyor direction on both the lift gate and truck floor is reversible.

### BRIEF DESCRIPTION OF THE DRAWINGS

In the drawings, like reference numerals and letters refer to the same parts throughout the various views, unless indicated otherwise from content, and wherein:

FIG. 1 is a side elevation of a cargo truck showing the design disclosed herein;

FIG. 2 is similar to FIG. 1, but shows a lift gate pivoted to a generally horizontal position; and

FIG. 3 is similar to FIGS. 1 and 2, but shows the lift gate vertically lowered relative to the position shown in FIG. 2.

### DETAILED DESCRIPTION

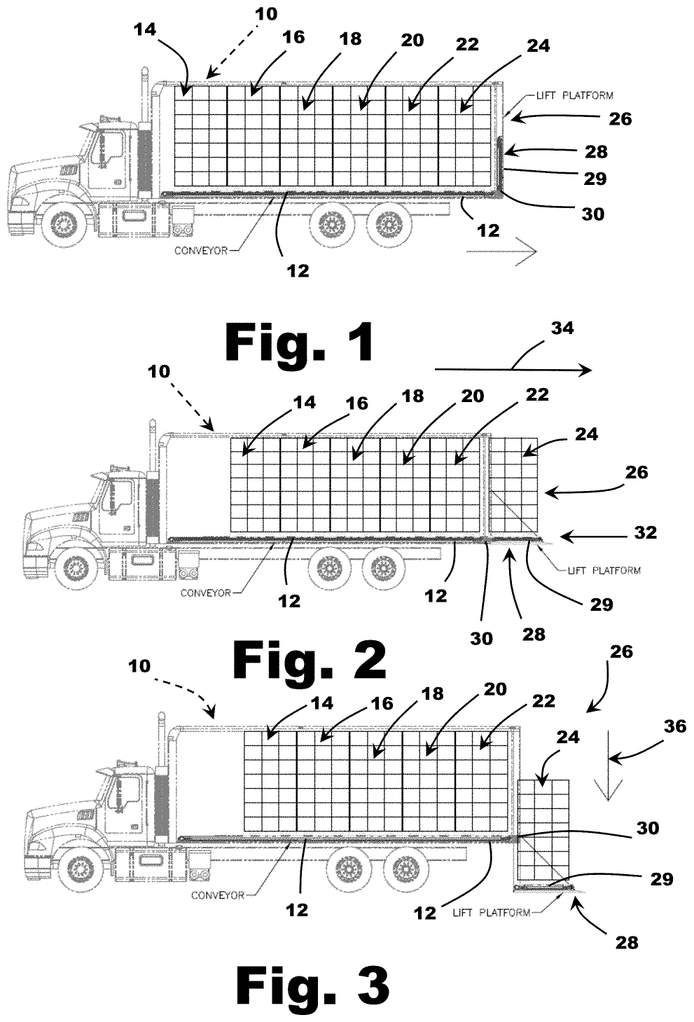

Referring now to the attached drawings, FIG. 1 illustrates a typical box truck design, with the box generally shown in dashed lines, indicated by reference numeral 10. Installed on the bed of the truck is a chain rail conveyor system, indicated generally at 12.

Palletized loads 14, 16, 18, 20, 22, 24 are schematically illustrated as floating slightly above the conveyor 12, with the intent being to illustrate these loads as resting on pallets on the endless chains (not shown) of the conveyor 12. The palletized loads 14, 16, 18, 20, 22, 24 more or less fill the interior of the truck's cargo space 10. As just mentioned, while the pallets are not specifically illustrated, it should be understood that each load 14, 16, 18, 20, 22, 24 is resting on an individual pallet.

Referring now to the back-end of the cargo space 10 (which is generally indicated by arrow 26), the present design has a “drawbridge”-type lift gate, or lift platform, indicated generally at 28. The lift gate 28 is designed to be pivoted about an axis that is generally located at the position of arrow 30.

When the truck is loaded and traveling to customer locations, or the like, the lift gate 28 is in the “up” position illustrated in FIG. 1. When the truck reaches the customer location, at that point, the lift gate 28 is pivoted down to the horizontal position indicated generally by arrow 32 in FIG. 2.

When in the horizontal position (see 32 in FIG. 2), the lift gate 28 is more or less co-planar with the truck's bed 12.

The lift gate 28 carries its own chain rail conveyor 29, similar to what was described in the 011 patent, but shortened to rest on the surface of the lift gate 28. The lift gate's conveyor may be powered in different ways, but in any event, it does not have any type of drive mechanism that extends above its vertical height. In this way, the entire load carried within the truck's cargo space 10 can be moved by the conveyor system, in the manner indicated by arrow 34 in FIG. 2. This leaves the end-most palletized load 24 resting on the lift gate 28.

At that point, and referring now to FIG. 3, the lift gate 28 and palletized load 24 may be lowered to the ground, as is generally indicated at 36. When the lift gate 28 (and load) are on the ground, the load can be removed by pallet forks (e.g., by forklift or pallet jack) or, alternatively, it may be possible to move the load off the lift gate platform 28 by other means, such as moving the truck or, possibly, activation of the lift gate's independent chain rail conveyor 29.

With respect to box truck deliveries, in particular, the foregoing design provides certain advantages for unloading cargo when a lift gate is required, such as, for example, allowing for easy unloading of the box truck at multiple locations where there may not be loading/unloading docks or the like. As indicated above, system operation could be made reversible for loading box trucks.

The foregoing design is currently under development. The purpose of this disclosure is to describe the ideas set forth above with sufficient clarity that they could be designed, developed, and/or built by others; and to provide support and priority for later-filed patent claims that may claim priority benefit of the present disclosure. It is to be understood that the design is under development as of the time of the present filing. As a consequence, the foregoing disclosure is not to be read in a limiting sense. Instead, the limitations of patent coverage are to be defined by the patent claim or claims that follow, the interpretation of which is to be made according to the well-defined doctrines of patent claim interpretation.

What is claimed is:

1. A truck cargo area having a floor that carries a first endless chain conveyor, and a lift gate that is adjacent to the floor, with the lift gate being pivotable about an axis, from a generally upstanding position to a generally horizontal position, and further, the lift gate carrying a second endless chain conveyor that moves into conveying alignment with the first endless chain conveyor when the lift gate is first pivoted to the generally horizontal position, and still further, after the lift gate has been pivoted to the generally horizontal position, the lift gate is then vertically movable for lowering the lift gate relative to a ground surface.
